(19) United States
(12) Patent Application Publication
(10) Pub. No.: US 2004/0130147 A1
(43) Pub. Date: Jul. 8, 2004

(54) Hose clamp

(76) Inventor: Martin Cousineau, Repentigny (CA)

Correspondence Address: Martin Cousineau, c/o PROTECTIONS EQUINOX INT'L INC., Suite 224, 4480, Cote-de-Liesse, Montreal, QC, H4N 2R1, CA

(21) Appl. No.: 10/716,566

(22) Filed: Nov. 20, 2003

Related U.S. Application Data
(60) Provisional application No. 60/429,534, filed on Nov. 29, 2002.

(51) Int. Cl. F16L 33/00

(52) U.S. Cl. 285/253; 285/242

(57) ABSTRACT

A clamp for a hose includes a loop, for disposing around the hose, which has two axially spaced apart looped ends. The clamp has a force generator, for drawing together the two looped ends, and which is connected to the two looped ends. The force generator has at least one disc spring mounted thereon. A spacer member is mounted on the force generator between the disc spring and one of the looped ends for axially transferring a clamping force from the force generator to the looped ends. The clamping force is sufficient to axially draw together the looped ends so as to clamp the hose.

### CROSS REFERENCE TO RELATED APPLICATIONS

Benefit of U.S. Provisional Application for Patent Serial No. 60/429,534, filed on Nov. 29, 2002, is hereby claimed.

### FIELD OF THE INVENTION

The present invention concerns clamps, more particularly to clamps for use with hoses.

### BACKGROUND OF THE INVENTION

Hose clamps are well known and widely used in industry and are practical and reliable in applications requiring large controllable holding force. Conventionally, hose clamps include a loop of resilient material such as stainless steel, steel or plastic, which loops around the outside wall of a hose and applies a clamping force thereto. However, there exist applications where it is desirable to apply and maintain constant torque forces against the hose clamp so as to retain high clamping forces during expansion and contraction of the hose during extremes of temperature and pressure. Such temperature and pressure fluctuations are typical for hoses used on, for example, automobile exhaust systems. In addition, mechanical stresses such as vibrations and dynamic stresses, normally encountered during operation of the automobile engine, are sufficient to dislodge hose clamps that are not clamped by sufficiently strong clamping forces.

A number of designs for hose clamps exist, including:

U.S. Pat. No. 5,010,626, issued Apr. 30, 1991 to Dominguez for “Hose clamp with flanged captive tensioning nut and pivoted bridge element”;

U.S. Pat. No. 5,720,086, issued Feb. 24, 1998 to Eliasson et al. for “Clamping collar”; and

WO 01/27516A1, published Apr. 19, 2001 to Dominguez.

These hose clamps, however, suffer from a number of important disadvantages. Each uses a bolt that applies a clamping force directly against a shoulder of a loop end. During application of high torque forces during the clamping operation, the force direction may not be axially applied in a constant manner due to deformation of the shoulder by the clamping forces. This non-constant application of torque force across the loop end may be prone to failure during temperature related expansion and contraction of the hose. In addition, some hose clamp designs use T-bolts and constant tension springs, which limit the amount of force that can be applied during clamping. Disadvantageously, most constant tension springs are made of steel, which is prone to corrosion and freezing under normal operations. Other types of hose clamps use worm gears to apply torque forces to the clamp, which worm gears may be unsuitable in operations requiring constant high clamping torque.

Thus there is a need for an improved heavy-duty hose clamp that can be used to apply and maintain high clamping forces.

### SUMMARY OF THE INVENTION

The present invention is directed towards a solution to the aforesaid problems by providing a heavy-duty hose clamp with a novel spacer that allows a user to axially apply constant significant torque forces during a clamping operation. A novel combination of the spacer, capture nuts and a number of axially aligned disc springs maintain constant high clamping forces around the hose. The capture nuts are shaped to allow inward transfer of the clamping forces from a bolt to looped ends to close the gap therebetween and to reduce the clamp loop around the hose. Advantageously, the clamp significantly increases the amount of working torque forces that are safely available to the user up to about 450 in-lbs. The hose clamp of the present invention is simple to operate and is manufactured from inexpensive, lightweight and readily available materials, such as stainless steel. The hose clamp can be custom made to fit many hose dimensions, up to about 35 inches in diameter, and uses readily available tools to apply the clamping forces to the bolt. In addition, the user can select many combinations of the disc springs' orientation to apply a variety of different clamping deflections for the clamping operation required.

In a first aspect of the present invention, there is provided a clamp for a hose, the clamp including a loop for disposing around the hose and having first and second axially spaced apart looped ends, the clamp comprising: a force generator, for drawing together the first and second looped ends, and connected to the first and second looped ends, the force generator including at least one disc spring mounted thereon; and a spacer member mounted on the force generator between the disc spring and the first looped end for axially transferring a clamping force from the force generator to the first and second looped ends, the clamping force being sufficient to axially draw together the first and second looped ends so as to clamp the hose.

Typically, the first looped end includes a first outer face and a first inner face, and the second looped end includes a second outer face and a second inner face, the first and second outer faces being angled inwardly towards each other and the first and second inner faces being curved and disposed inwardly towards each other. The first looped end includes first and second holes located in the respective first outer and inner faces and the second looped end includes third and fourth holes located in the respective second outer and inner faces, the holes being axially aligned with each other.

Typically, the force generator includes a bolt having a first bolt end and a second bolt end, the bolt passing through the first, second, third and fourth holes. The bolt includes a threaded portion and a non-threaded portion, the non-threaded portion extending through and away from the first looped end. The disc spring and the spacer member are slidably mounted on the non-threaded portion, the disc spring being located near the first bolt end.

Typically, the force generator further includes a first capture nut mounted in the first looped end and a second capture nut mounted in the second looped end. The first capture nut includes a non-threaded axial bore. The second capture nut includes a threaded axial bore. The first and second capture nuts each includes a curved end and a stem portion.

Typically, the spacer member includes a cylindrical collar with an axial bore sized to accommodate the bolt therein, the cylindrical collar having a force receiver end and a force transfer end.

Typically, the stem portion of the first capture nut is disposed towards the first hole of the first looped end and abuts the force transfer end.

Typically, the second looped end includes one hole that is axially aligned with the first and second holes of the first looped end.

In another aspect of the present invention, the force generator is a T-bolt that passes though the first and second holes of the first looped end and through the one hole of the second looped end, the T-bolt having a T-bolt end and a threaded bolt portion on which is movably mounted a nut, the T-bolt end being located in the second looped end. The nut includes a smooth outer surface on which are mounted the disc springs and a threaded bore through which the T-bolt passes.

Typically, the second bolt end includes a stop. The stop is a lock nut, a Stover nut or a nylon insert nut.

Typically, the Stover nut or the nylon insert nut are integral with the stem portion of the second capture nut.

Typically, the first hole of the first looped end is larger than the second hole of the first looped end.

Typically, the clamp loop, when viewed in cross section, includes a planar portion and two ends that are angled away from the surface of the hose.

Typically, the clamp, as described above, includes a plurality of paired disc springs.

Typically, a plate is hingeable connected to the first looped end.

Typically, the hose is a heavy-duty hose.

In an alternative aspect of the present invention, there is provided a clamp having a clamp loop for receiving therein an item for clamping, the clamp loop being disposable axially along a main axis of the item, the clamp loop having first and second moveable looped ends, each looped end having respective inner and outer faces, the inner faces being continuous with an inner periphery of the clamp loop, the outer faces being continuous with an outer periphery of the clamp loop, the inner faces, when in a non-clamping configuration, defining a gap therebetween, the clamp loop being sufficiently resilient to allow the moveable looped ends to move towards each other, when subjected to clamping forces, to attain a clamping configuration in which the item is clamped between the inner periphery of the clamp loop, the looped ends having respective first axially aligned openings for passing therethrough a force generator, the force generator cooperating with one of the outer faces to apply an inwardly directed force thereto to move the moveable looped ends towards each other, the clamp comprising: a spacer axially aligned with the first axially aligned openings, the spacer cooperating with one of the outer faces to axially transfer the inwardly directed force from the force generator to the moveable looped ends; and at least one disc spring axially aligned with the spacer and the force generator, the disc springs being cooperable with the force generator to transfer the inwardly directed force to the moveable looped ends, the disc springs being sufficiently resilient to contract against each other when the inwardly directed clamping force is applied thereto.

### BRIEF DESCRIPTION OF THE DRAWINGS

Further aspects and advantages of the present invention will become better understood with reference to the description in association with the following Figures, wherein:

FIG. 1 is a perspective view of an embodiment of a hose clamp of the present invention;

FIG. 1a is a cross section view taken along line 1a-1a of FIG. 1;

FIG. 2 is a side view of the hose clamp of FIG. 1;

FIG. 3a is a partial cutaway view of a number of disc springs cooperating with a bolt of FIG. 1;

FIG. 3b is a perspective view of a spacer member;

FIG. 4a is a perspective view of a looped end;

FIG. 4b is a side view of a looped end with a capture nut located therein;

FIG. 5a is a side view of one capture nut;

FIG. 5b is an end view taken along line 5b of FIG. 5a;

FIG. 5c is a side view of a unitary capture nut/Stover nut;

FIG. 5d is a side view of a unitary capture nut/Nylon insert;

FIG. 6a is a side view of another capture nut;

FIG. 6b is an end view taken along line 6b of FIG. 6a;

FIG. 7 illustrates a number of disc spring configurations viewed in cross section;

FIG. 8 is a top view of a hingeable plate;

FIG. 9 is a side view of a second embodiment of the hose clamp;

FIG. 9a is a perspective view of a T-bolt engaged a looped end;

FIG. 9b is a side view of FIG. 9a;

FIG. 9c is a partial cutaway side view of a nut of FIG. 9;

FIG. 10 is a side view of a third embodiment of the hose clamp; and

FIG. 11 is a side view of a fourth embodiment of the hose clamp.

### DETAILED DESCRIPTION OF THE PREFERRED EMBODIMENTS

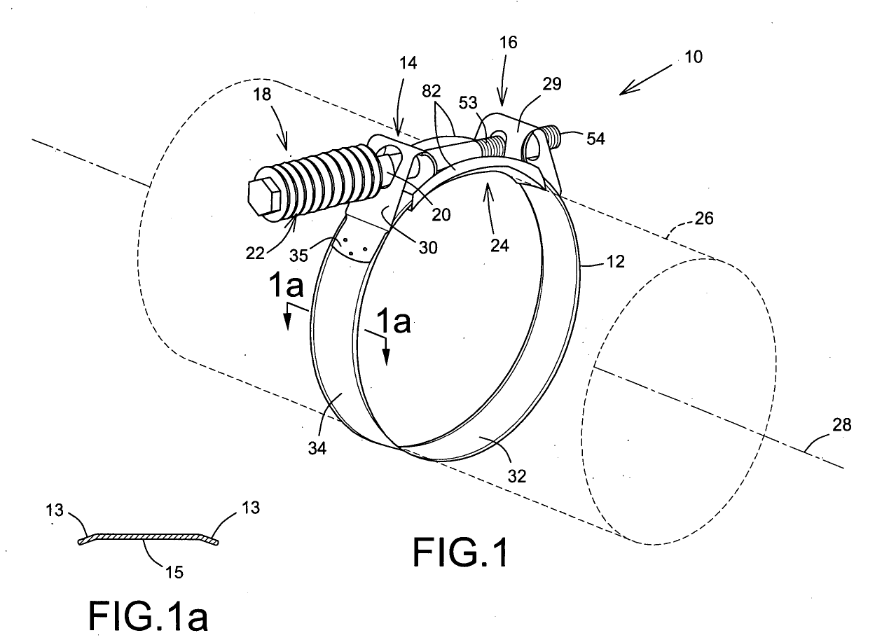

An embodiment of a hose clamp 10 of the present invention is shown in FIG. 1. Broadly speaking, the clamp 10 includes a clamp loop 12, two moveable looped ends 14 and 16, a force generator 18, a separator or spacer member 20, a plurality of disc springs 22, and a hingeable plate 24.

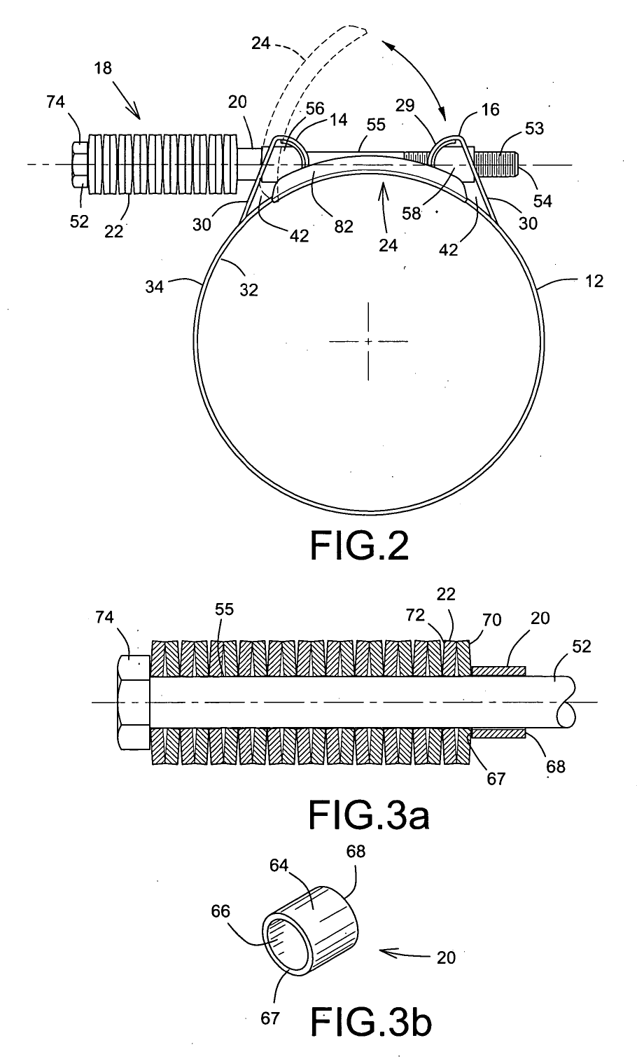

Referring now to FIGS. 1 and 2, in a typical application, an item for clamping, for example a high-pressure, heavy-duty hose 26 is received in the clamp loop 12. The clamp loop 12 is disposable axially along a main axis 28 of the hose 26 and annularly around the hose 26. The clamp loop 12 is typically made of stainless steel, which has sufficient resilience to withstand high operating torque forces applied thereto. The clamp loop 12 includes the two moveable looped ends 14 and 16, one of which will now be described in detail with reference to FIGS. 1 and 2. The looped end 14 has an inner face 29 and an outer face 30. The inner face 29 is continuous with an inner periphery surface 32 of the clamp loop 12. The outer face 30 is continuous with an outer periphery surface 34 of the clamp loop 12 and is angled inwardly. Typically, the clamp loop 12 is machined from a single piece of material, the ends of which are looped back on themselves and connected to the outer periphery surface 34 by a securing means 35 known to those skilled in the art. An example of such securing means include stamping, welding or staples and the like. In a default, non-clamping configuration, the inner faces 29 are axially spaced apart from each other and define a gap therebetween. The clamp loop 12 materials are sufficiently resilient to allow the moveable looped ends 1.4 and 16 to move towards each other, when subjected to clamping forces. In a clamping configuration, the hose 26 is clamped between the inner periphery surface 32 of the clamp loop 12 by the force generator 18 acting against the moveable looped ends 14 and 16.

As best illustrated in FIG. 1a, the clamp loop 12, in a clamping configuration when viewed in cross section, includes two ends 13 that are curved away from the hose 26 surface and a generally planar portion 15 which rests against the surface of the hose 26. The two curved ends 13 prevent the clamp loop 12 from biting into the hose 26 during clamping and reduce damage to the surface of the hose 26.

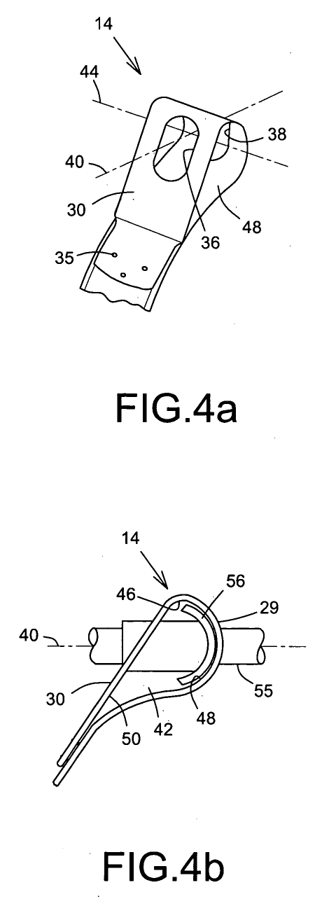

Referring now to FIGS. 4a and 4b, each of the looped ends 14 and 16 has two openings or holes 36 and 38 disposed therein. The holes 36 and 38 are axially aligned with each other and with the holes of the other moveable looped end. The holes 36 and 38 have an axis 40, which are aligned generally perpendicularly to the main axis 28 of the hose 26 during clamping. The hole 36 is disposed outwardly, whereas the hole 38 is disposed inwardly towards the gap. The hole 36 is generally of a larger size than hole 38 and is elliptical to allow the user to move the force generator 18 up and down to allow the force generator to be aligned with the hole 38. In addition, each of the looped ends 14 and 16 include a second opening 42, which has a second opening axis 44 that is generally perpendicular to the axis 40 and which is generally parallel to the main axis of the hose 26. The moveable looped ends 14 and 16 each have an inner surface 46 that defines the second opening 42. The inner surface 46 has a curved portion 48 and a generally planar portion 50. The curved portion 48 is disposed inwardly towards the other looped end and the gap.

Referring to FIGS. 2 and 3a, the force generator 18 passes through the holes 36 and 38 and cooperates with one of the outer faces 30 to apply an inwardly directed force thereto to draw the moveable looped ends 14 and 16 towards each other. In this embodiment, the force generator 18 is a bolt 52 that is sized to pass through each of the holes 36 and 38. The bolt 52 typically includes threads along a threaded portion 53 and a non-threaded smooth portion 55 on which the disc springs 22 are slidably mounted to allow for their smooth compression and expansion. The bolt 52 also includes a first bolt end 74 and a second bolt end 54.

Referring to FIGS. 2, 5a, 5b, 6a and 6b, the force generator 18 also includes two capture nuts 56 and 58 are positioned in the second openings 42. Both capture nuts 56 and 58 cooperate with the inner surface of the looped ends 14, 16 to generate the inwardly directed forces thereon. The capture nut 56 has a non-threaded axial bore 57, whereas the capture nut 58 has a threaded axial bore 59, both bores 57 and 59 are sized to allow engagement with the bolt 52. The bolt 52, in the clamping configuration extends through each of the bores 57 and 59, the end 54 of the threaded bolt extends outwardly from capture nut 58. Both capture nuts 56 and 58 include a curved end portion 60 and a stem portion 62. The curved end portion 60 cooperates with the curved portion 48 of the looped end 14, 16 and is disposed towards the gap. The stem portion 62 is disposed towards the planar portion 50 of the looped ends 14, 16. The stem 62 of the capture nut 56, located in the looped end 14, is cooperable with the spacer 20 to receive the inwardly directed force thereagainst. Both capture nuts 56 and 58 have elongate sides 61 and a shorter side 63. A projection 65 extends outwardly from the shorter side 63 of the capture nut 56 and acts to reduce up and down movement of the hingeable plate 24 when the clamp is in operation.

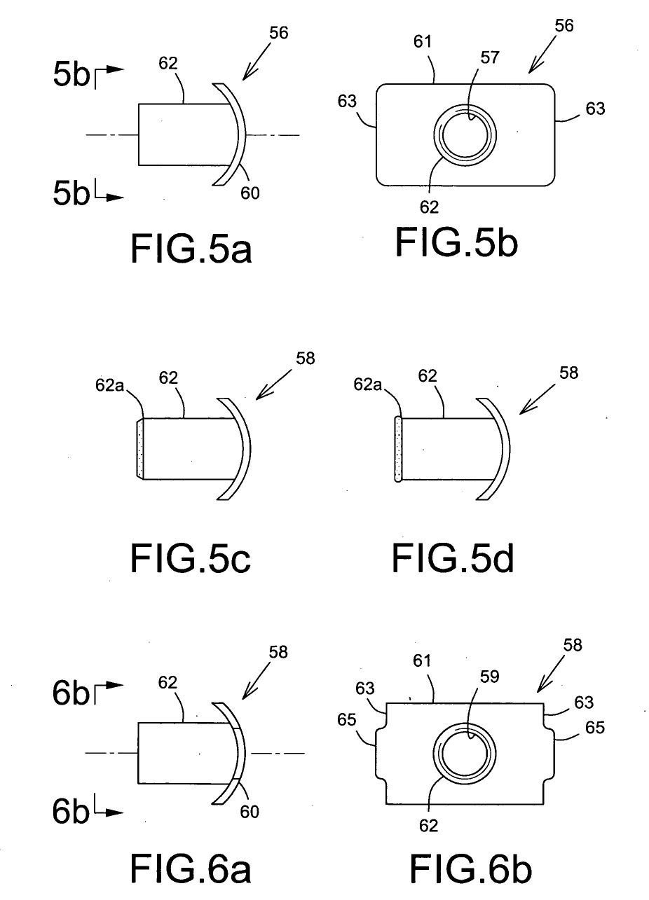

As shown in FIGS. 5c and 5d, a stop 62a in the form of a lock nut, a Stover nut or a nylon insert nut may be added to the bolt end 54 after torquing to damp against major vibrations, and rests against the stem 62 of the capture nut 58. Alternatively, the capture nut and the stop 62a may be a unitary piece 62a, in which the Stover nut and nylon insert nut are integral with the stem 62.

Referring to FIGS. 2, 3a, and 3b, the spacer member 20 of the present invention is axially aligned with the holes 36 and 38 in the looped ends 14, 16. The spacer member 20 is orientated towards the outer face of the looped end 14 to axially transfer the inwardly directed force from the bolt 52 to move the moveable looped ends 14, 16 together. The spacer member 20 is a cylindrical collar 64 with an axial bore 66 of sufficient size to slide over a non-threaded portion of the threaded bolt 52. The cylinder 64 has a force receiver end 67 and a force transfer end 68. The force receiver end 67 abuts a first face 70 of one of the disc springs 22. The force transfer end 68 abuts the stem portion 62 of the capture 56. Both the ends 66 and 68 have planar surfaces for contacting the stem 62 and the first face 70 of the disc spring 22.

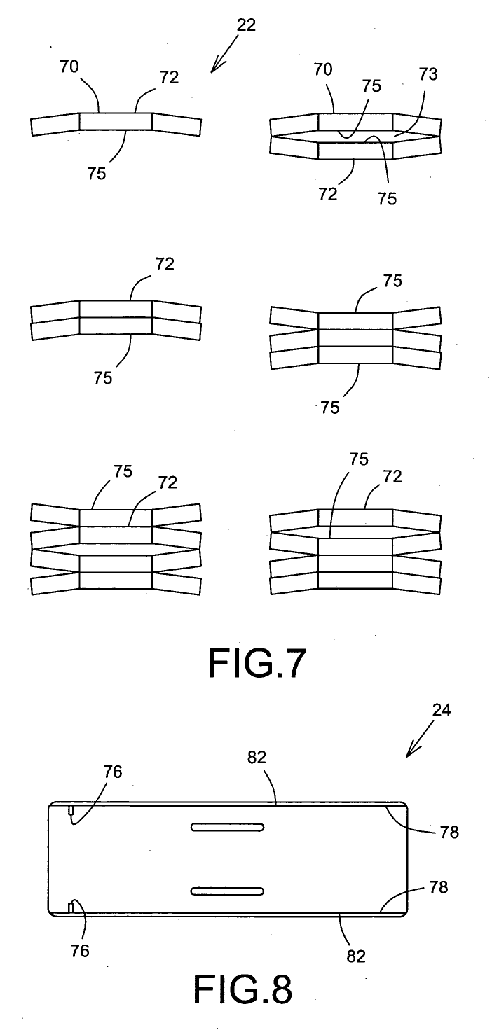

Referring to FIGS. 3a and 7, the disc springs 22 are axially aligned with the spacer member 20 and the bolt 52 and transfer the inwardly directed force to the moveable looped ends 14, 16. In this embodiment, a number of the disc springs 22 are arranged in pairs along the non-threaded portion of the bolt 52. Each pair of the disc springs 22 includes the first face 70, a second face 72 and a central space 73 defined by a generally concave inner face 75. The second face 72 cooperates with the bolt end head 74 to receive the clamping force thereagainst. One skilled in the art will recognize that the disc springs 22 can be used in many different configurations (as shown in FIG. 7) and that they have sufficient resilience to contract against each other when forces are applied to one or both faces 70 and 72. One skilled in the art will also recognize that one disc spring 22 may be used with the bolt 52 such that either of the First or second faces 70, 72 and the inner face 75 receives the clamping force from the bolt end head 74. When the hose 26, after clamping, expands outwardly such as during operations when the hose 26 carries high temperature, high pressure fluids such as water, steam, or oil, the outward expansion forces act against the inner periphery surface 32 of the clamp loop 12 and act against the inwardly directed clamping force to maintain constant clamping force. The disc springs 20 have sufficient-resilience to deform during the expansion such that the size of the central space 73 decreases thereby taking up the increase in the inwardly directed force of the force generator 18 to compensate for the expansion of the hose 26. Similarly, as the hose 26 cools, it will contract and the central space 73 of the disc springs 22 will increase in size, the disc springs 22 attaining their dish-like appearance and the force generator 18 will retain its maximum constant clamping force against the disc springs 22 and against the hose 26. Conventional hose clamps have a maximum clamping torque of about 160 in-lbs torque working force, whereas with the hose clamp 10 of the present invention, this increases significantly up to about 450 in-lbs torque working force.

Referring to FIGS. 1, 2 and 8, the hingeable plate 24 is hingeably connected to one of the looped ends 14. The plate 24 is continuous with the inner clamp loop periphery 32 and includes two inward projections 76. The plate 24 may also include a single bar in place of the two projections 76, which may be positioned across the plate to lock the plate 24 in place during clamping. The hingeable plate 24 acts as a bridge across the gap and includes a guide portion 78 located on an outer face 80 for guiding the moveable looped ends 14 and 16 along a path of travel towards and away from each other during clamping. The guide portion 78 includes two opposing edge walls 82 axially aligned with the openings 36 and 38. The plate 24 allows the user a means by which the looped ends 14 and 16 can be aligned and allows maneuverability of the clamp 10 along the hose 26 before clamping. The plate 24 may optionally be swung out of alignment (as shown in outline in FIG. 2) with the looped ends 14 and 16 should the user need to completely disengage the hose clamp 10 from the hose 26.

Operation

Referring to FIGS. 1 and 2, generally, the hose clamp 10 is supplied in a default configuration with the bolt 52 disconnected from the looped ends 16 and 18 and the capture nuts 56 and 58. Depending on the torque that is required, the user selects the appropriate number of disc springs 22 and adds them to the shaft of the bolt 52 and slides the spacer member 20 onto the bolt 52 shaft. The bolt 52 is positioned adjacent the non-threaded bore 57 of the capture nut 56 and with the hose 26 to be clamped in place snuggly against the inner periphery 32, the operator aligns the bolt end 54 with the hole 38 and the threaded bore 59 of the capture nut 58. The user then applies a turning force to the bolt end 74 causing the moveable ends 14 and 16 to slide along the plate 24 towards each other thereby tightening the clamp 10 around the hose 26 to the required torque. Alternatively, the clamp 10, with the disc springs 22, the spacer member 20 and capture nuts 56 and 58 aligned, is slipped over the hose 26, which is connected to a fluid source (not shown). The clamp 10 is then tightened as described.

Alternatives

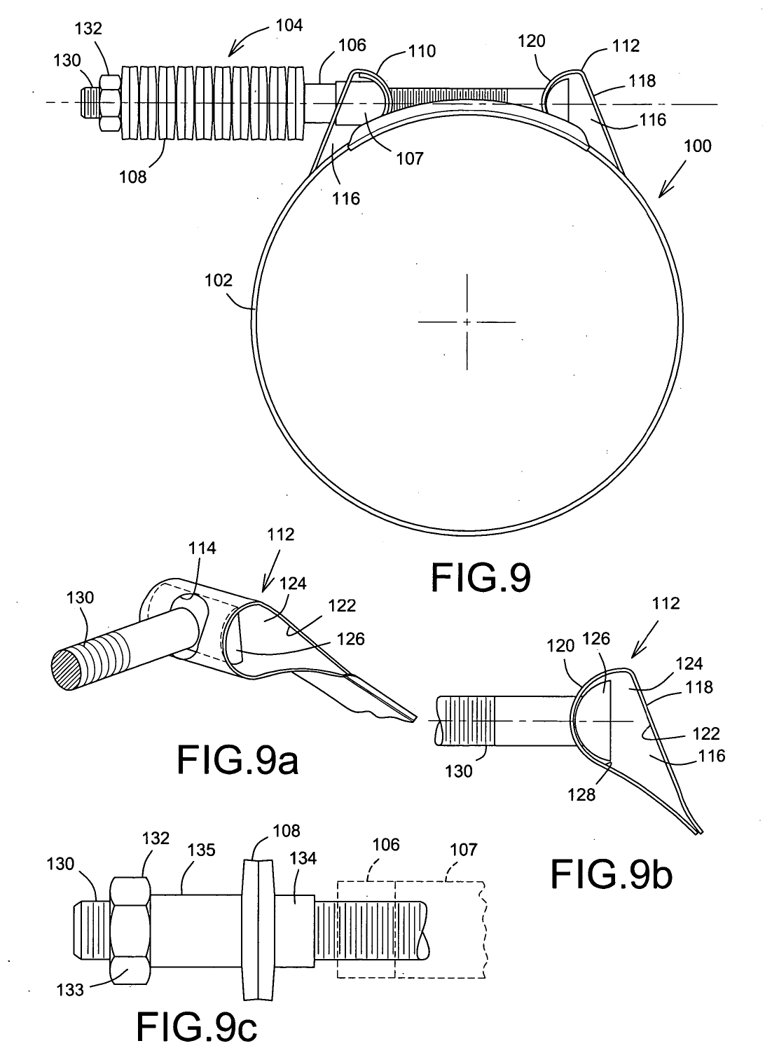

The first embodiment of the hose clamp 10 is useful in many clamping operations. There may be applications, such as for hoses in areas of limited accessibility that require the use of a T-bolt in combination with the disc springs, the spacer member and a hingeable plate which has limited movement. A second embodiment 100, illustrated in FIG. 9, operates in essentially the same way as the first embodiment 10 and includes a clamp loop 102, a force generator 104, a spacer member 106, a capture nut 107, disc springs 108, and two moveable looped ends 110 and 112. The differences between 10 and 100 will now be described with reference to FIGS. 9a, 9b and 9c.

The looped end 112 includes a hole 114, an opening 116, a generally planar outward face 118 and a curved inward face 120. A shaped inner surface 122 defines the second opening 11.6, a planar portion 124 of which lies adjacent a T-bolt end 126: During clamping, the T-bolt end 126 pushes against a curved surface 128 of the second opening 116 and inwardly transfers the clamping force as the force generator 104 acts inwardly against the looped end 110, as described for the clamp 10. The force generator 104 includes an elongated threaded bolt portion 130 and a nut 132 mounted on the bolt threads.

As best illustrated in FIG. 9c, the nut 132 has a smooth outer surface 134, on which the disc springs 108 (only two are shown) are mounted for sliding and abutment against the spacer member 106, and a threaded bore (not shown) through which the bolt 130 passes during clamping. Unlike with the clamp 10, turning the bolt 130 causes the disc springs 108 to move along the smooth surface 134 of the nut 132 towards the spacer member 106, while the nut 132 moves down the bolt 130 shaft. The nut 132 may alternatively include a nut head 133 that is separate from a smooth surfaced sleeve 135 and still work the same way as the unitary nut 132.

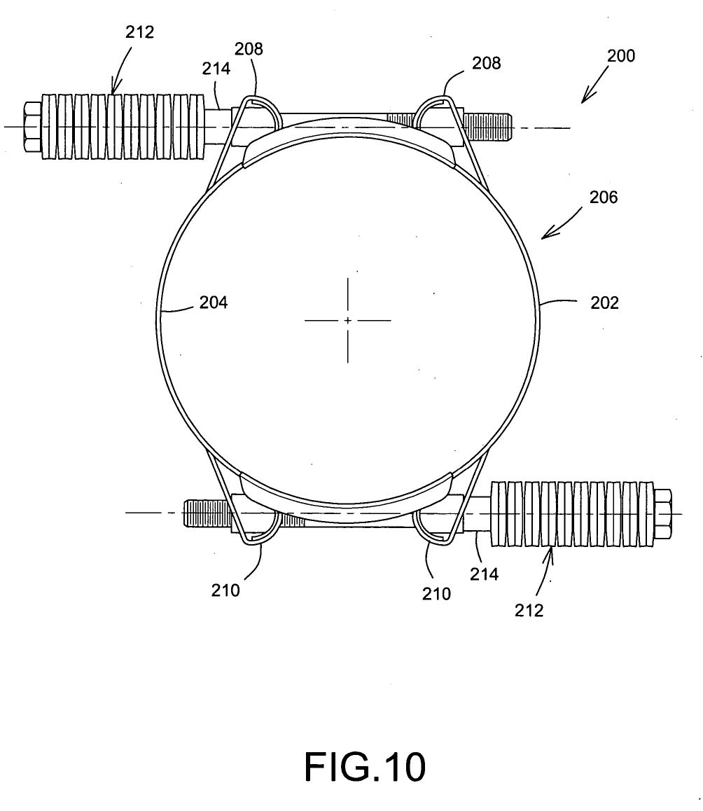

A third embodiment of a hose clamp 200 is illustrated in FIG. 10 and operates in the same way as the first embodiment of the hose clamp 10. There may be clamping applications that require the use of a hose clamp loop that has two gaps between two sets of movable looped ends. The hose clamp 200 includes first and second clamp portions 202 and 204, which together form a clamp loop 206. Two sets of moveable looped ends 208 and 210 are moveable by two force generators 212 with two spacer members 214.

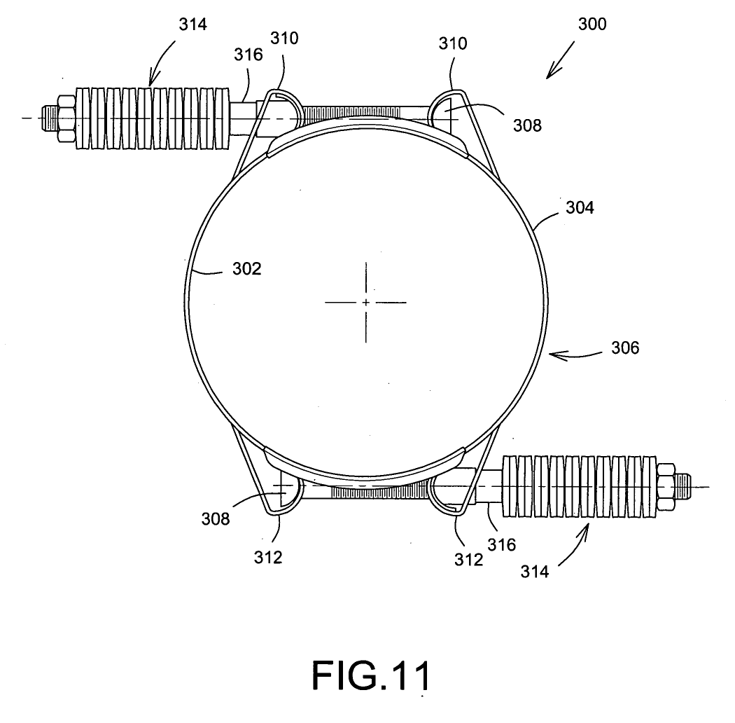

A fourth embodiment of a hose clamp 300 is illustrated in FIG. 11 and is structurally similar to the second embodiment 200. The hose clamp 300 includes first and second clamping portions 302 and 304, which together form a clamp loop 306. Two T-bolts 308 are used together with two sets of moveable looped ends 310 and 312, which are moveable by two force generators 314 with two spacer members 316.

While a specific embodiment has been described, those skilled in the art will recognize many alterations that could be made within the spirit of the invention, which is defined solely according to the following claims.

What is claimed is:

1. A clamp for a hose, the clamp including a loop for disposing around the hose and having first and second axially spaced apart looped ends, the clamp comprising:
a force generator, for drawing together the first and second looped ends, and connected to the first and second looped ends, the force generator including at least one disc spring mounted thereon; and
a spacer member mounted on the force generator between the disc spring and the first looped end for axially transferring a clamping force from the force generator to the first and second looped ends, the clamping force being sufficient to axially draw together the first and second looped ends so as to clamp the hose.

2. The clamp, according to claim 1, in which the first looped end includes a first outer face and a first inner face, and the second looped end includes a second outer face and a second inner face, the first and second outer faces being angled inwardly towards each other and the first and second inner faces being curved and disposed inwardly towards each other.

3. The clamp, according to claim 2, in which the first looped end includes first and second holes located in the respective first outer and inner faces and the second looped end includes third and fourth holes located in the respective second outer and inner faces, the holes being axially aligned with each other.

4. The clamp, according to claim 3, in which the force generator includes a bolt having a first bolt end and a second bolt end, the bolt passing through the first, second, third and fourth holes.

5. The clamp, according to claim 4, in which the bolt includes a threaded portion and a non-threaded portion, the non-threaded portion extending through and away from the first looped end.

6. The clamp, according to claim 5, in which the disc spring and the spacer member are slidably mounted on the non-threaded portion, the disc spring being located near the first bolt end.

7. The clamp, according to claim 6, in which the force generator further includes a first capture nut mounted in the first looped end and a second capture nut mounted in the second looped end.

8. The clamp, according to claim 7, in which the first capture nut includes a non-threaded axial bore.

9. The clamp, according to claim 8, in which the second capture nut includes a threaded axial bore.

10. The clamp, according to claim 9, in which the first and second capture nuts each includes a curved end and a stem portion.

11. The clamp, according to claim 10, in which the spacer member includes a cylindrical collar with an axial bore sized to accommodate the bolt therein, the cylindrical collar having a force receiver end and a force transfer end.

12. The clamp, according to claim 11, in which the stem portion of the first capture nut is disposed towards the first hole of the first looped end and abuts the force transfer end.

13. The clamp, according to claim 2, in which the second looped end includes one hole that is axially aligned with the first and second holes of the first looped end.

14. The clamp, according to claim 13, in which the force generator is a T-bolt that passes though the first and second holes of the first looped end and through the one hole of the second looped end, the T-bolt having a T-bolt end and a threaded bolt portion on which is movably mounted a nut, the T-bolt end being located in the second looped end.

15. The clamp, according to claim 14, in which the nut includes a smooth outer surface on which are mounted the disc springs and a threaded bore through which the T-bolt passes.

16. The clamp, according to claim 12, in which the second bolt end includes a stop.

17. The clamp, according to claim 16, in which the stop is a lock nut, a Stover nut or a nylon insert nut.

18. The clamp, according to claim 17, in which the Stover nut or the nylon insert nut are integral with the stem portion of the second capture nut.

19. The clamp, according to claim 2, in which the first hole of the first looped end is larger than the second hole of the first looped end.

20. The clamp, according to claim 1, in which the clamp loop, when viewed in cross section, includes a planar portion and two ends that are angled away from the surface of the hose.

21. The clamp, according to claim 1, includes a plurality of paired disc springs.

22. The clamp, according to claim 1, in which a plate is hingeable connected to the first looped end.

23. The clamp, according to claim 1, in which the hose is a heavy-duty hose.
